(19) United States
(12) Patent Application Publication
(10) Pub. No.: US 2026/0245534 A1
(43) Pub. Date: Aug. 20, 2026

(54) ELECTRONIC DEVICE, METHOD AND COMPUTER PROGRAM

(71) Applicant: Sony Group Corporation, Tokyo (JP)

(72) Inventors: Piergiorgio SARTOR, Stuttgart (DE); Giorgio FABBRO, Ostfildern (DE)

(73) Assignee: Sony Group Corporation, Tokyo (JP)

(21) Appl. No.: 19/161,736

(22) PCT Filed: Mar. 11, 2024
(86) PCT No.: PCT/EP2024/056411

§ 371 Date: Sep. 3, 2025

(30) Foreign Application Priority Data
Mar. 23, 2023 (EP) 23163812.3

(51) Int. Cl. G10H 1/00; G06N 3/0895; H05B 47/105

(52) U.S. Cl. CPC G10H 1/0025; G06N 3/0895; G10H 2210/105; G10H 2220/201; G10H 2220/455; G10H 2250/311; H05B 47/105

(57) ABSTRACT

An electronic device comprising circuitry configured to generate Event-based Vision Sensor (EVS) data and generate and/or control sound based on the Event-based Vision Sensor (EVS) data.

### TECHNICAL FIELD

The present disclosure generally pertains to the field of audio processing, and in particular, to device, method and computer program for audio generation and audio enhancement.

### TECHNICAL BACKGROUND

It is known that an RGB (Red-Green-Blue) camera is a visible light camera designed to create digital images that replicate human vision, capturing light in red, green, and blue wavelengths (RGB) for accurate color representation. Each sensor in an RGB camera captures the light intensity in red, green, and blue levels, and thus, the signal coming from an RGB camera depends on the absolute brightness intensity of the light reaching each sensor.

Using an EVS (Event-based Vision Sensor) camera alleviates much of the signal processing that would be required with a standard RGB camera, as only changes are detected in the input scene. For example, a signal coming from an EVS camera will not be dependent on the absolute brightness intensity of the light reaching the sensor and which is not always a useful information in image processing.

Moreover, cameras with fixed frame rate, like the RGB ones, have a much larger latency than the EVS ones. An EVS camera typically have a latency lower than 1 ms, while the RGB camera has a latency around 10 ms.

In some cases, images or videos could be associated, for example, to music produced by an instrument.

Although there generally exist techniques for remixing audio content, it is generally desirable to improve methods and apparatus for audio generation and audio enhancement.

### SUMMARY

According to a first aspect, the disclosure provides an electronic device comprising circuitry configured to generate Event-based Vision Sensor (EVS) data and generate and/or control sound based on the Event-based Vision Sensor (EVS) data.

According to a second aspect, the disclosure provides a method for training a neural network, the method comprises mapping audio parameters based on detected Event-based Vision Sensor (EVS) data, comparing ground truth data of the audio parameters with the audio parameters to obtain a comparison result, and feeding back to the neural network the comparison result to up-date the neural network parameters.

According to a third aspect, the disclosure provides a method comprising generating Event-based Vision Sensor (EVS) data and generating and/or controlling sound based on the Event-based Vision Sensor (EVS) data.

According to a fourth aspect, the disclosure provides a computer program comprising instructions, the instructions when executed on a processor causing the processor to generate Event-based Vision Sensor (EVS) data and generate and/or control sound based on the Event-based Vision Sensor (EVS) data.

According to a fifth aspect, the disclosure provides an electronic device comprising circuitry configured to generate Event-based Vision Sensor (EVS) data and detect vibrations based on the Event-based Vision Sensor (EVS) data.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically shows a process of directly generating an audio source from a detected event;

FIG. 2 schematically shows a process of generating an audio source from an event detected based on sound generator vibrations, such as loudspeaker vibrations;

FIG. 3 schematically shows a process of generating an audio source from an event detected based on sound generator vibrations, such as drum vibrations;

FIG. 4 schematically shows a process of generating an audio source from an event detected based on public motions/movements;

FIG. 5 schematically shows a process of generating an audio source from an event detected based on music band motions/movements;

FIG. 6 schematically shows a process of a training a neural network for generating an audio source based on a motion dependent generated event;

FIG. 7 schematically shows a process of generating an audio source based on gesture mapping;

FIG. 8 schematically shows a process of generating an audio source and a light source based on generated events;

FIG. 9 shows a flow diagram of a method for generating a sound based on detected events; and

FIG. 10 shows a block diagram depicting an embodiment of an electronic device that can implement the processes of generating an audio source and controlling audio parameters based on motion dependent generated events.

### DETAILED DESCRIPTION OF EMBODIMENTS

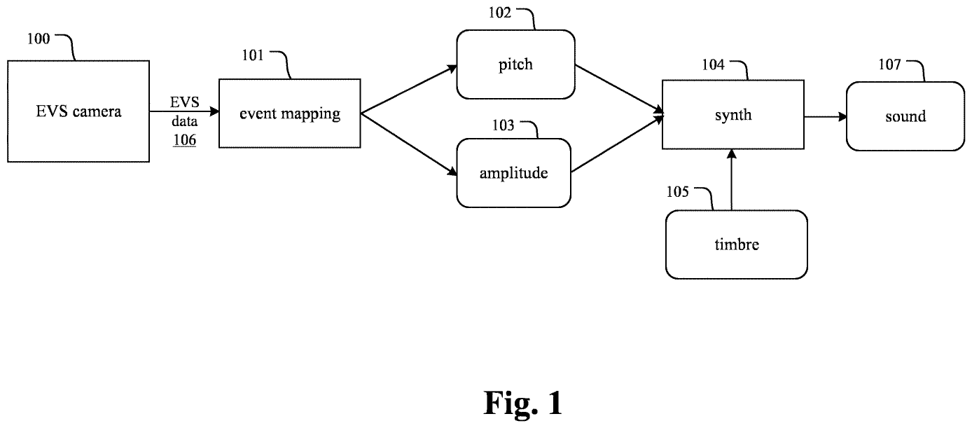

Before a detailed description of the embodiments under reference of FIGS. 1 to 10 are given, general explanations are made.

It is generally known that artists and performers often explore new ways to render music, for example in the context of live performances. More parameters may now be controlled using electronic instruments, and the musicians are equipped with means for more expressivity. The scale of controllability of a single instrument goes beyond what a single musician can do, therefore sometimes, the music produced by an instrument may be associated e.g., to external events, like images, videos or a scene. In this manner the performance of the musician may become more interactive or may increase the variety in the musician's performance in an automatic way.

It has been recognized that event camera technology may allow to measure rapidly minimal variations in a scene. For example, these events may be used to support music generation, e.g., by adding an instrument controlled by the events.

Consequently, some embodiments pertain to an electronic device comprising circuitry configured to generate Event-based Vision Sensor (EVS) data and generate and/or control sound based on the Event-based Vision Sensor (EVS) data.

The electronic device may be a digital (video) camera, such as an Event-based Vision Sensor (EVS) camera, an edge computing enabled image sensor, such as smart sensor associated with smart speaker, or the like, a smartphone, a personal computer, a laptop computer, a personal computer, a wearable electronic device, electronic glasses, professional music equipment or the like, a circuitry, a processor, multiple processors, logic circuits or a mixture of those parts.

The circuitry may include one or more processors, logical circuits, memory (read only memory, random memory, etc., storage memory, i.e., hard disc, compact disc, flash drive, etc.), an interface for communication via a network, such as a wireless network, internet, local area network, or the like, a CMOS (Complementary Metal Oxide Semiconductor) image sensor, a CCD (Charge Coupled Device) image sensor, or the like.

The Event-based Vision Sensor (EVS) data may be data generated by an EVS camera. An EVS camera is designed to emulate the way that the human eye senses light. In the EVS camera, the incident light is converted into electric signals in an image light receiving circuit. The signals pass through an amplitude unit and reach a comparator where the differential luminance data is separated and divided into positive and negative signals which are then processed and output as events. Using an EVS camera delivering “events”, i.e., changes, of the scene, enrichment of the music performance may be achieved. Furthermore, the EVS allows to create new musical instruments as well, by directly associating the musician(s) movements in front of the camera with some sound rendering. Therefore, creativity of artists or of any person in general may be improved. An EVS camera has high speed of event generation due to the low latency. Detection of an EVS event may be immediately available.

Generate sound may be performed by synthesizing a sound. Control an audio source may be performed by adjusting/changing an audio parameter, such as pitch, amplitude, attack, decay, release, sustain and the like. Generating and/or controlling the audio source may be performed by using a gesture and/or when a user directly uses a predetermined camera mode, or the like.

In some embodiments, the circuitry may comprise an Event-based Vision Sensor configured to generate Event-based Vision Sensor (EVS) data. The electronic device may include a camera (EVS or not) and a sound rendering device/system, without limiting the present disclosure in regard. Alternatively, the electronic device may include a camera (EVS or not) and another electronic device may include a sound rendering device/system. For example, the electronic device may be a music synthesizer, professional music and stage lighting equipment, PC hardware and software, PlayStation, and the like.

In some embodiments, the Event-based Vision Sensor (EVS) may be configured to generate the Event-based Vision Sensor (EVS) data based on luminance changes from each pixel of Event-based Vision Sensor (EVS). In the EVS camera, every pixel of the image sensor of the camera is sensitive to the change of illumination. The luminance changes detected by each pixel may be filtered to extract only those that exceed the predetermined threshold value. In other words, the EVS camera will detect every motion in the scene it's pointing to, provided that the change in luminance caused by such motion exceeds a programmable threshold. This event data may be combined with the pixel coordinate, time, and polarity information before being output. Each pixel may operate asynchronously, independently from any other.

In some embodiments, the Event-based Vision Sensor (EVS) data may be generated based on vibration motion of a sound generator.

In some embodiments, the sound generator may be a loudspeaker, a drum, a guitar amplifier, a bass amplifier or the like.

In some embodiments, the Event-based Vision Sensor (EVS) data generation may be related to a gesture movement.

In some embodiments, the circuitry may be further configured to perform event mapping to map audio parameters to the Event-based Vision Sensor (EVS) data. For example, the audio parameters may be pitch, amplitude, attack, decay, release, sustain and the like. During the event mapping, an event is mapped to e.g., the pitch, and thus, when this event occurs a change in pitch is performed.

In some embodiments, the circuitry may be further configured to change the audio parameters based on the event mapping to obtain the sound. For example, when an event occurs that is mapped e.g., to the amplitude, a change in amplitude is performed.

In some embodiments, the audio parameter may be pitch and/or amplitude, without limiting the present disclosure in that regard. Alternatively, the audio parameters may be attack, decay, release, sustain and the like.

In some embodiments, the circuitry may be further configured to perform synthesis based on the audio parameters to generate and/or to control the audio source. The synthesis may be performed by a synthesizer that generates and/or controls the audio parameters, such as the pitch, the amplitude, and the like, to generate the sound. For example, the synthesiser may be controlled by pitch control information and/or by amplitude control information. The synthesiser may be an external device or may be part of the electronic device. The synthesiser may be a subunit of the electronic device, such as a sound chip having a synthesiser integrated therein. In other words, the synthesiser may be for example, an electronic musical instrument that generates audio signals, a programmable sound generator (PSG), a software synthesizer (softsynth), namely a computer program that generates digital audio, or the like. The programmable sound generator (PSG) is a sound chip that generates (or synthesizes) audio signals built from one or more basic waveforms. The synthesiser creates sounds by generating waveforms through methods including subtractive synthesis, additive synthesis and frequency modulation synthesis. The software synthesizer or softsynth is a computer software that creates sounds or music is not new, but advances in processing speed.

In some embodiments, the synthesis may comprise audio synthesis being performed based on a timbre. For example, during synthesis, the audio parameters may be controlled based on a timbre to generate the sound.

In some embodiments, the circuitry may be further configured to perform quantization and filtering of the Event-based Vision Sensor (EVS) data to obtain filtered event data.

In some embodiments, the circuitry may be further configured to perform gesture mapping to map the Event-based Vision Sensor (EVS) data to a detected gesture. For example, when a gesture performed by a user is detected, an audio source may be generated and/or controlled by e.g. changing an audio parameter, such as pitch, amplitude and the like.

In some embodiments, the circuitry may be further configured to control light based on the filtered Event-based Vision Sensor (EVS) data. For example, when an event is detected, such as a motion of a user, a gesture performed by a user or the like, a light may be controlled, e.g., the light color, intensity, direction and the like. Similarly, when another event is detected an audio source, e.g., a sound may be generated and/or controlled.

Some embodiments pertain to a method for training a neural network, the method comprises mapping audio parameters based on detected Event-based Vision Sensor (EVS) data, comparing ground truth data of the audio parameters with the audio parameters to obtain a comparison result, and feeding back to the neural network the comparison result to update the neural network parameters.

Some embodiments pertain to a method comprising generating Event-based Vision Sensor (EVS) data and generating and/or controlling an audio source based on the Event-based Vision Sensor (EVS) data.

Some embodiments pertain to a computer program comprising instructions, the instructions when executed on a processor causing the processor to generate Event-based Vision Sensor (EVS) data and generate and/or control an audio source based on the Event-based Vision Sensor (EVS) data.

Some embodiments pertain to an electronic device comprising circuitry configured to generate Event-based Vision Sensor (EVS) data and detect vibrations based on the Event-based Vision Sensor (EVS) data. For example, the electronic device may be an Event-based Vision Sensor (EVS) camera used to detect vibrations.

The circuitry may include one or more processors, logical circuits, memory (read only memory, random memory, etc., storage memory, i.e., hard disc, compact disc, flash drive, etc.), an interface for communication via a network, such as a wireless network, internet, local area network, or the like, a CMOS (Complementary Metal Oxide Semiconductor) image sensor, a CCD (Charge Coupled Device) image sensor, or the like.

The vibrations may be detected based on the Event-based Vision Sensor (EVS) data generated by an EVS camera. The EVS camera generates, per pixel, the sign of the time derivative of the light intensity, together with the time indication of when this change happens. If nothing changes, it does not generate anything. Using an EVS camera delivering “events”, i.e., changes, of the scene, enrichment of the music performance may be achieved. Furthermore, the EVS allows to create new musical instruments as well, by directly associating the musician(s) movements in front of the camera with some sound rendering. Therefore, creativity of artists or of any person in general may be improved. An EVS camera has high speed of event generation due to the low latency. Detection of an EVS event may be immediately available.

Some embodiments pertain to a method comprising generating Event-based Vision Sensor (EVS) data and detecting vibrations based on the Event-based Vision Sensor (EVS) data.

Some embodiments pertain to a computer program comprising instructions, the instructions when executed on a processor causing the processor to perform generating Event-based Vision Sensor (EVS) data and detecting vibrations based on the Event-based Vision Sensor (EVS) data.

### Inference Phase

FIG. 1 schematically shows a process of directly generating an audio source from a detected event.

An Event-based Vision Sensor (EVS) camera 100 detects an event, such as a motion e.g., of a hand of a user, and acquires EVS data 106. The EVS event data 106 include a plurality of events generated based on a motion, such as gesture, movement, and the like. The EVS data 106 is already combined with e.g., the pixel coordinates, time, and polarity information before being output to an event mapping 101. The event mapping 101 is performed based on the EVS data 106 to map audio parameters, such as pitch 102, i.e. x→pitch and amplitude 103 i.e. y→amplitude, with an event comprised in the EVS data 106. For example, the X-axis of the pixel coordinate is mapped to an audio parameter, such as the pitch 102 and the Y-axis of the pixel coordinate is mapped to the amplitude (volume) 102. In this manner, if an event is detected, i.e., motion is detected in the X-axis the pitch of an audio source changes and if an event is detected, i.e., motion is detected in the Y-axis the amplitude of the audio source changes. The pitch 102 and the amplitude 103 are input to a synthesiser. A synthesis 104 is performed based on the pitch 102 and the amplitude 103 and based on a timbre 105 to generate an audio source 107, such as a sound, an instrument, and the like. The timbre 105 is for example, a parameter of a sound. An example of the timbre 105 may also be a cut-off filter parameter, such as frequency.

In the example described above, the X-axis of the pixel coordinate is mapped to, for example, pitch and the Y-axis of the pixel coordinate is mapped, for example, to the amplitude of a sound signal. Here, the X value of the event may be directly mapped to frequency. Assuming that an event sensor provides values x_event in the range of x=0 to x_max and assuming that the frequency f of the sound should fall in the range f_min to f_max, then a direct mapping of x_event to frequency f may for example realized by a linear mapping of x value x_event to frequency f according to f=f_min +x_event/x_max*(f_max−f_min). In alternative embodiments, filtering and quantization may be applied to the mapping. For example, the frequency may be limited to notes of a certain scale.

In the embodiment of FIG. 1, the user, e.g., musician, moves the hand(s) in front of the EVS camera and the events generated are directly used to render a sound, for example pitch and volume as horizontal and vertical event creation. For example, the X, Y coordinates may be translated to pitch and amplitude using a look-up table, or the like.

In the embodiment of FIG. 1, the synthesiser 104 is controlled by pitch control information 102 and amplitude control information 103 received from the event mapping 101. The synthesiser 104 may be an external device or may be part of the main device, here of the EVS camera 100.

The synthesiser may be a subunit of the main device, such as a sound chip having a synthesiser integrated therein. In other words, the synthesiser may be for example, an electronic musical instrument that generates audio signals, a programmable sound generator (PSG), a software synthesizer (softsynth), namely a computer program that generates digital audio, or the like.

A synthesizer or other tone generator may for example be controlled by a microcontroller, using a Musical Instrument Digital Interface protocol (MIDI), which is a way for musical computers to communicate with each other. A MIDI message is a series of bytes sent from a controller to a playback device using asynchronous serial communication. Each byte of a MIDI message is ei-ther a command byte or status byte. For example, to play a note on a piano, which is usually the first channel (or channel 0) a note-on command byte may be sent followed by a pitch status byte and a velocity, or volume, status byte, e.g.,
0x90 (note on, channel 0),
0x45 (69 in base 10, or A4, 440 Hz),
0x40 (64 in base 10, or medium loud).

In other words, to generate a sound the synthesiser needs the above three commands. That is, to play a note a control command, such as:
midicommand(0x90, pitch, velocity);
   may be used, wherein 0x90 defines the midi [note on] control message, pitch defines the note to be played (e.g. 69 representing A 4, with frequency 440 Hz), velocity defines the loudness of the note to be played (e.g. 64 indicating medium loud). Applying this control command repetitively a note-by-note pitch change may be performed.

Alternatively, the pitch of a note that is played can be controlled by a pitch bend command, such as:
midicommand(0xe0, lsb, msb);
   wherein 0xE0 defines a midi pitch bend control message, Isb and msb are the least significant byte and most significant byte of a 14-bit number. A pitch bend of 0 bends 2 semitones down, while 16383 bends 2 semitones up.

As an alternative to the discrete note on/off commands (0x80, 0x90) and the pitch bend command (0xE0) described above, parameters of sound output can be controlled by a so-called “ContinuousController” MIDI message:
midicommand(0xb0, control function, control value);
   where “control function” defines the function to control, such as modulation (0x01), volume (0x07), expression (0x0B), effect 1 (0x0C), or others.

The above examples do not limit the present embodiment in that regard. Alternatively, other audio parameters may be controlled, such as the ADSR, namely the attack, decay, release, sustain.

Still alternatively, other effects may be controlled, such as the phaser effect. A phaser is an electronic sound processor used for filtering a signal. The phaser has a series of troughs in its frequency-attenuation graph. The position (in Hz) of the peaks and troughs are e.g., modulated by an internal low-frequency oscillator so that they vary over time, creating a sweeping effect. Generally, phasers are used to give a “synthesized” or electronic effect to natural sounds, such as human speech.

### Audio Source Generation Based on Vibration Dependent Generated Events

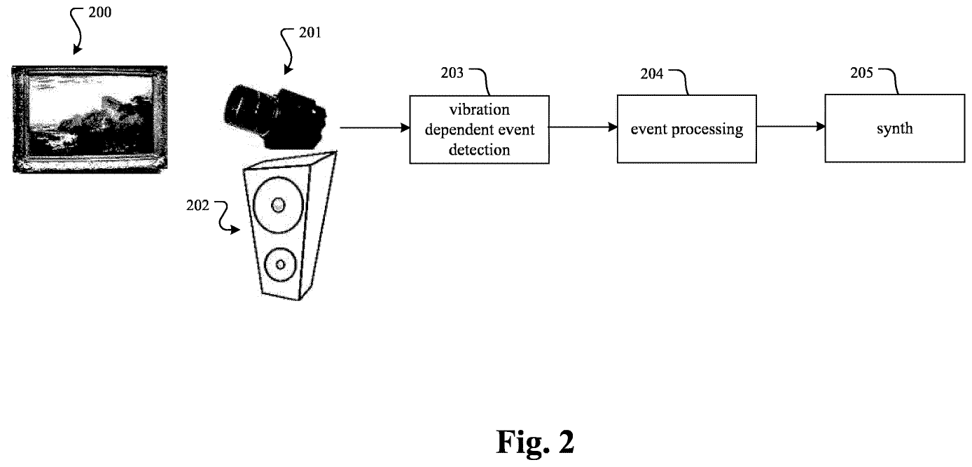

FIG. 2 schematically shows a process of generating an audio source from an event detected based on sound generator vibrations, e.g., loudspeaker vibrations. An EVS camera 201, which points towards a scene, here a still image 200, is placed on a loudspeaker 202. For example, vibrations related to a sound that is rendered from the loudspeaker 202 cause events generations. Vibration dependent event detection 203 is performed to detect the events generations which are independent of the scene, since the scene is a still image and to obtain EVS data (see 106 in FIG. 1). Event processing 204 is performed on the EVS data 106 to obtain audio parameters which can control a synthesiser. A synthesis 205 is performed based on the audio parameters to generate an audio source, such as a sound. The audio parameters may for example be pitch, amplitude, or the like.

Typically, an EVS camera is utilized to detect changes in the scene it's pointing to; even if the scene is still, if the support the camera is mounted on vibrates, the camera will perceive a reciprocal change in the light hitting the sensor and will generate a signal. This comes at no cost in the way the sensor is constructed, and the subsequent signal processing is carried out. This may not be the case for a standard image sensor, where a vibration may cause motion blur in the produced signal and, therefore, a loss of information.

A vibration may only reliably be detected given a fast response time by the camera. An EVS camera is generally faster than an RGB camera, both in terms of latency and in terms of data rate, e.g. in an EVS camera the information passes through quicker than in an RGB one and also the information that passes through is much more.

An EVS camera in this context may be better than for example a general vibration sensor in that the signal that a vibration sensor generates may only refer to the magnitude of the vibration, e.g., possibly a scalar quantity, while the EVS camera produces also spatial coordinates related to the vibration information, which may be used by the later processing stages to realize more complex control paradigms.

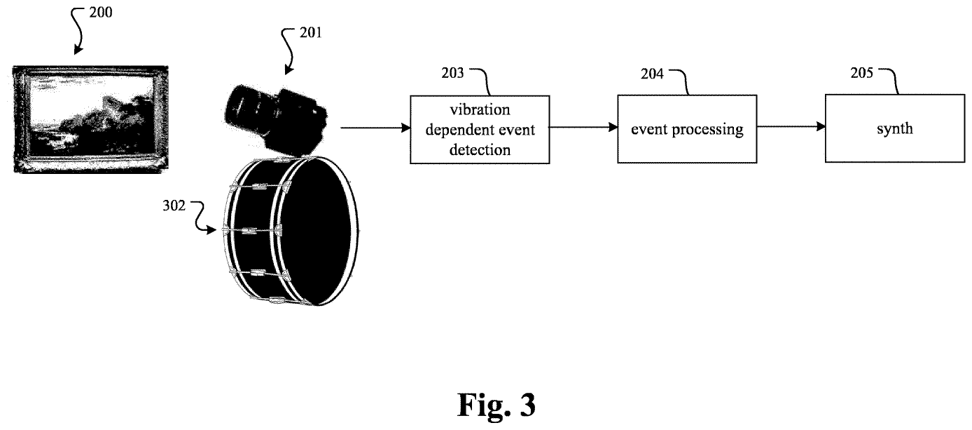

FIG. 3 schematically shows a process of generating an audio source from an event detected based on sound generator vibrations, e.g., drum vibrations. An EVS camera 201, which points towards a scene, here a still image 200, is placed on a drum 302. For example, a musician plays the drum and thus vibrations are generated from the drum 302 and cause events generations. Vibration dependent event detection 203 is performed to detect the events generations and to obtain EVS data (see 106 in FIG. 1). Event processing 204 is performed on the EVS data to obtain audio parameters. An audio synthesis 205 is performed based on the audio parameters to generate an audio source, such as a sound. The audio parameters may for example be pitch, amplitude, or the like.

In the embodiment of FIGS. 2 and 3, the EVS camera is placed on a loudspeaker (see 202 in FIG. 2) or a drum (see 302 in FIG. 3) and points towards a scene. The vibration of the support causes events generations, here EVS data, which are used to control a synthesizer or alternatively an effect unit.

During event processing 204, the event data are translated to audio parameters. This may be performed by considering that the amplitude of the oscillations of the loudspeaker/drum is dependent on the rhythm of the music. So, the amplitude of the EVS data (how much the pixel values change) is mapped to the amplitude of the generated sound. In this way a rhythmic component is obtained.

Harmony and pitch may be related to how shapes are arranged in the input signal, e.g., in the x-y space. For example, by clustering (spatially) the input data and associating every portion of the x-y space (e.g., top-right, bottom-left) to a chord or a component of a chord (root note, third, fifth, etc . . . ).

In this way, varying harmonic components depending on which part of the image contains some signal are obtained. This varies depending on the picture the EVS camera is pointing to.

### Audio Source Generation Based on Motion Dependent Generated Events

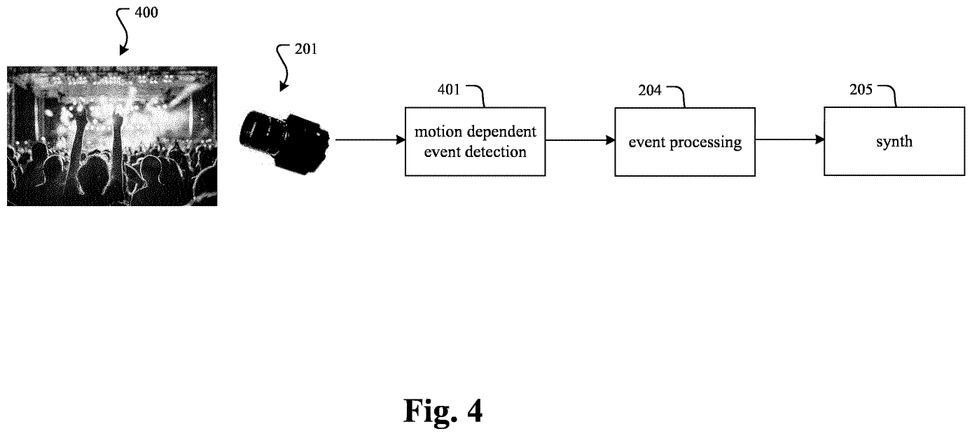

FIG. 4 schematically shows a process of generating an audio source from an event detected based on public motions/movements. An EVS camera 201 points towards a scene, which is a moving public 400 at a concert. Motion dependent event detection 401 is performed to detect events generations generated from the motion of the public. The detected events are translated to EVS data. Event processing 204 is performed on the EVS data (see 106 in FIG. 1) to obtain audio parameters. A synthesis 205 is performed based on the audio parameters to generate an audio source, such as a sound.

In the embodiment of FIG. 4, the EVS camera points towards the public that moves, and this affects the resulting sound rendering. Here the public is people attending a concert of e.g., their favourite band, and they dance under the sound of a song that the band is currently playing. The audio parameters may for example be pitch, amplitude, or the like.

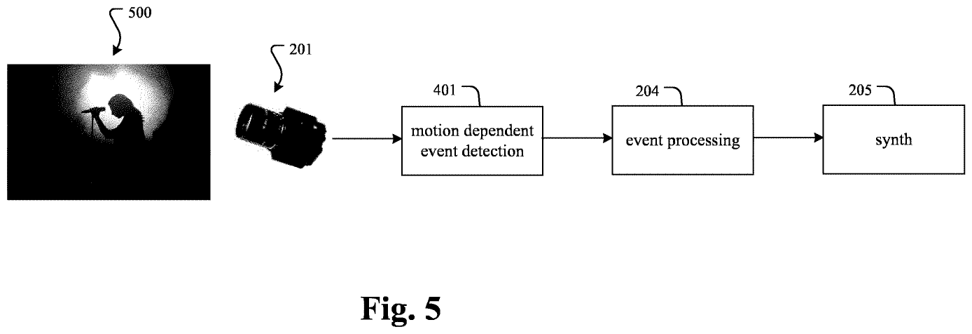

FIG. 5 schematically shows a process of generating an audio source from an event detected based on music band motions/movements. An EVS camera 201 points towards a scene, which is a music band 500 that moves while playing songs at a concert. Motion dependent event detection 401 is performed to detect events generations generated from the motion of the music band. The detected events are translated to EVS data (see 106 in FIG. 1). Event processing 204 is performed on the EVS data to obtain audio parameters. A synthesis 205 is performed based on the audio parameters to generate an audio source, such as a sound.

In the embodiment of FIG. 5, the EVS camera points towards the music band that moves while singing at a concert, and this affects the resulting sound rendering. For example, during their concert the music band may perform a specific choreography and the movements of the band are used to alter the sound. The audio parameters may for example be pitch, amplitude, or the like.

### Training Phase

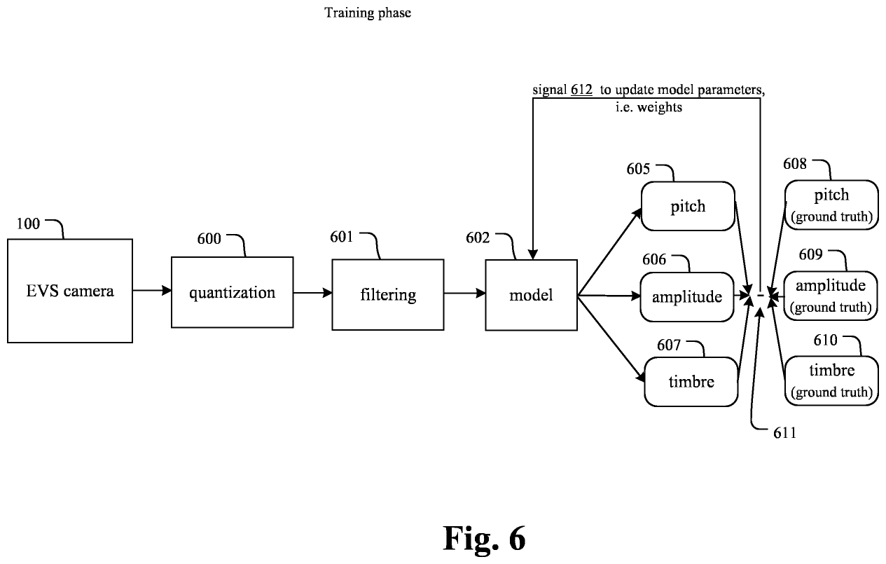

FIG. 6 schematically shows a process of a training a neural network for generating an audio source based on a motion dependent generated event. An EVS camera 100 acquires EVS data caused by a motion. A quantization 600 is performed on the EVS data to obtain quantized EVS event data. The quantization 600 divides in smaller areas the image captured from the EVS camera 100 and specifies which area is related to which event. A filtering 601 is performed on the quantized EVS data to obtain filtered EVS data. The filtering 601 comprises scaling the event data in order to reduce them and thus, is performed to reduce the complexity of calculations on the event data. A machine learning model 602 receives as input the filtered EVS data and output audio parameters, such as pitch 605, amplitude 606 and timbre 607. The machine learning model 602 uses for training purposes a physical phenomenological machine learning or a ruleset-based machine learning algorithm, such as a look-up table, to perform correlate the EVS event data with the audio parameters, such as pitch 605, amplitude 606 and timbre 607. During training, these audio parameters are compared with the respective ground truth audio parameters, i.e., the ground truth of the original audio, such as ground truth pitch 608, ground truth amplitude 609 and ground truth timbre 610, to obtain a comparison result. This comparison result is transmitted to the model 602 by a signal 612 used to update the model parameters, i.e., the weights.

In the embodiment of FIG. 6, the physical machine learning model transforms EVS data into audio parameters. The machine learning model may be for example, a neural network, a more generic machine learning model, or a rule-based algorithm.

In the rule-based approach the user may explicitly define the rules for mapping the EVS data to the audio parameters, e.g., without using machine learning model. This mapping may be stored in a look-up table.

In the machine learning approach, no rule is required to be explicitly defined by the user, since everything is extracted from the data.

It should be noted that a synthesiser which receives as input the audio parameters, e.g., pitch, amplitude and timbre, and outputs sound, may be in theory replaced by a physical model of a piano string that describes how much or fast the piano strings are vibrating. For example, the physical machine learning model may be used to change the harmonies by changing the audio parameters.

In the embodiment of FIG. 6, the events are recorder together with a “timbre”, i.e., a set of parameters for the instrument/effect unit. During the training phase the correspondences between the events and the timbre are learned. Later the result of the correspondence is learnt for a performance in a different setting where a different scene in front of the camera generates different events. After the training phase, the system/device uses a parametrized model that has learnt how to perform, i.e., how to adjust the pitch, the amplitude, the timbre based on the performance and/or gestures of a user.

### Audio Source Generation Based on Gesture Mapping

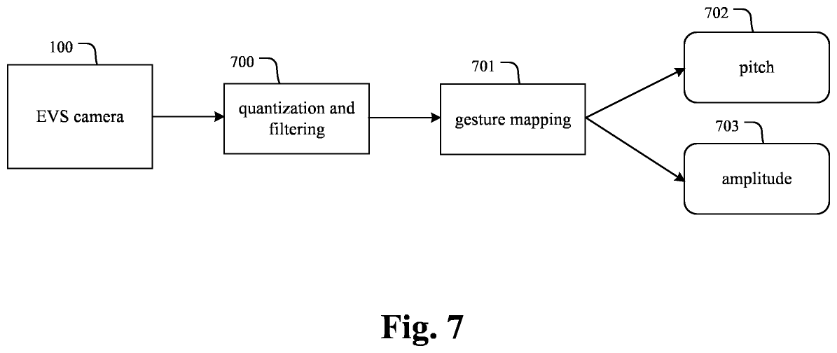

FIG. 7 schematically shows a process of generating an audio source based on gesture mapping.

An EVS camera 100 acquires EVS data caused by a motion. A process of quantization and filtering 700 is performed on the EVS data to obtain quantized and filtered EVS data. A gesture mapping 701 is performed on the quantized and filtered EVS data to map the EVS data with to a predefined table of gestures, wherein each gesture is mapped to a change in pitch 700 and amplitude 703.

### Audio Source Generation and Light Control

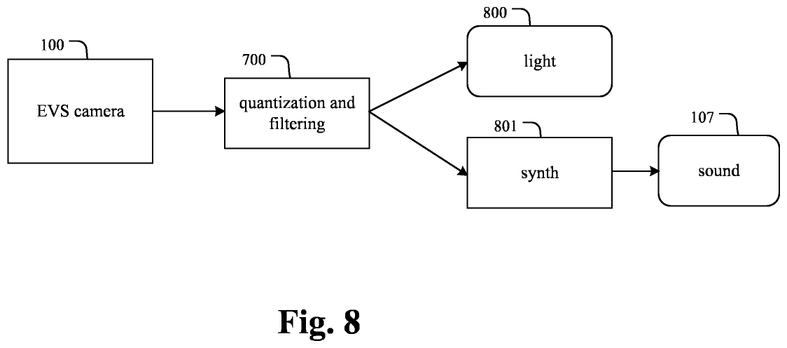

FIG. 8 schematically shows a process of generating an audio source and a light source based on generated events. An EVS camera 100 acquires EVS data caused by a motion. A process of quantization and filtering 700 is performed on the EVS data to obtain quantized and filtered EVS data. Based on the EVS data a light 800 is controlled, such as the lights of a musical show, or the like, and a synthesis 801 is performed to generate an audio source.

### Method

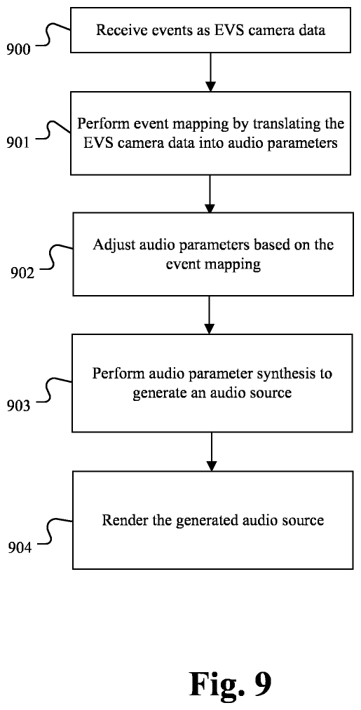

FIG. 9 shows a flow diagram of a method for generating a sound based on detected events.

At 900, events are detected and received as EVS camera data. At 901, event mapping is performed by translating the EVS camera data into parameters. At 902, the parameters are adjusted based on the detected events. At 903, parameter synthesis is performed to generate a sound. At 904, rendering of the generated sound is performed.

### Implementation

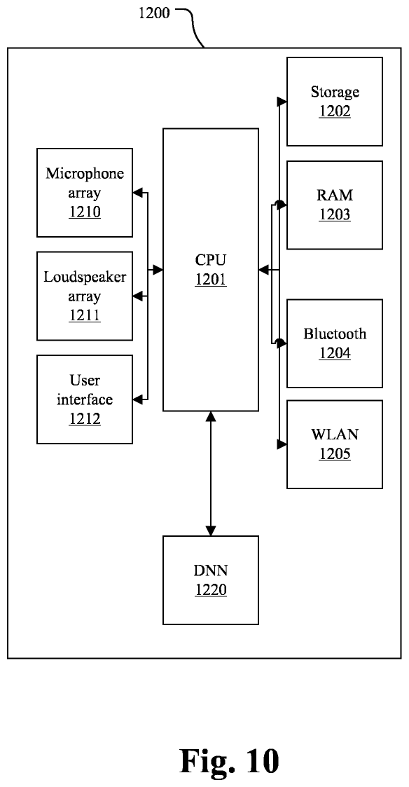

FIG. 10 shows a block diagram depicting an embodiment of an electronic device that can implement the processes of generating an audio source and controlling audio parameters based on motion dependent generated events. The electronic device 1200 comprises a CPU 1201 as processor. The electronic device 1200 further comprises a microphone array 1210, a loudspeaker array 1211 and a neural network unit 1220 that are connected to the processor 1201. The neural network unit 1220 may for example be an artificial neural network in hardware, e.g., a neural network on GPUs or any other hardware specialized for the purpose of implementing an artificial neural network. Loudspeaker array 1211 consists of one or more loudspeakers that are distributed over a predefined space and is configured to render 3D audio. The electronic device 1200 further comprises a user interface 1212 that is connected to the processor 1201. This user interface 1212 acts as a man-machine interface and enables a dialogue between an administrator and the electronic system. The user interface 1212 may be a graphical user interface (GUI). Still further, an administrator may make configurations to the system using this user interface 1212. The electronic device 1200 further comprises a Bluetooth interface 1204, and a WLAN interface 1205. These units 1204, 1205 act as I/O interfaces for data communication with external devices. For example, additional loudspeakers, microphones, and video cameras with Ethernet, WLAN or Bluetooth connection may be coupled to the processor 1201 via these interfaces 1204, and 1205.

The electronic system 1200 further comprises a data storage 1202 and a data memory 1203 (here a RAM). The data memory 1203 is arranged to temporarily store or cache data or computer instructions for processing by the processor 1201. The data storage 1202 is arranged as a long-term storage, e.g., for recording sensor data obtained from the microphone array 1210 and provided to or retrieved from the DNN unit 1220. The data storage 1202 may also store audio data that represents audio messages, which the public announcement system may transport to people moving in the predefined space.

It should be noted that the description above is only an example configuration. Alternative configurations may be implemented with additional or other sensors, storage devices, interfaces, or the like.

It should be further noted that alternatively the electronic device 1200 may be implemented with a digital signal processor (DSP) or a graphics processing unit (GPU), without limiting the present disclosure in that regard.

It should also be noted that the division of the electronic device of FIG. 10 into units is only made for illustration purposes and that the present disclosure is not limited to any specific division of functions in specific units. For instance, at least parts of the circuitry could be implemented by a respectively programmed processor, field programmable gate array (FPGA), dedicated circuits, and the like.

It should be recognized that the embodiments describe methods with an exemplary ordering of method steps. The specific ordering of method steps is, however, given for illustrative purposes only and should not be construed as binding.

All units and entities described in this specification and claimed in the appended claims can, if not stated otherwise, be implemented as integrated circuit logic, for example, on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) An electronic device comprising circuitry configured to
generate (100; 203; 303) Event-based Vision Sensor (EVS) data (106); and
generate and/or control (104) sound (107) based on the Event-based Vision Sensor (EVS) data (106).

(2) The electronic device of (1), wherein the circuitry comprising an Event-based Vision Sensor configured to generate Event-based Vision Sensor (EVS) data (106).

(3) £ The electronic device of (2), wherein the Event-based Vision Sensor (EVS) is configured to generate the Event-based Vision Sensor (EVS) data (106) based on luminance changes from each pixel of Event-based Vision Sensor (EVS).

(4) The electronic device of any one of (1) to (3), wherein the Event-based Vision Sensor (EVS) data (106) are generated based on vibration motion of a sound generator (202).

(5) The electronic device of any one of (1) to (4), wherein the sound generator is one of a loudspeaker (202), a drum (302), a guitar amplifier, a bass amplifier.

(6) The electronic device of any one of (1) to (5), wherein the Event-based Vision Sensor (EVS) data (106) generation is related to a gesture movement.

(7) The electronic device of any one of (1) to (6), wherein the circuitry is further configured to perform event mapping (101) to map audio parameters (102, 103) to the Event-based Vision Sensor (EVS) data (106).

(8) The electronic device of (7), wherein the circuitry is further configured to change the audio parameters (102, 103) based on the event mapping (101) to obtain the sound (107).

(9) The electronic device of (8), wherein the audio parameter is pitch (102) and/or amplitude (103).

(10) The electronic device of (8), wherein the circuitry is further configured to perform synthesis (104) based on the audio parameters (102, 103) to generate and/or to control the sound (107).

(11) The electronic device of (10), wherein the synthesis (104) comprises audio synthesis being performed based on a timbre (105).

(12) The electronic device of any one of (1) to (11), wherein the circuitry is further configured to perform quantization and filtering (700) of the Event-based Vision Sensor (EVS) data (106) to obtain filtered event data.

(13) The electronic device of (12), wherein the circuitry is further configured to perform gesture mapping (701) to map the Event-based Vision Sensor (EVS) data (106) to a detected gesture.

(14) The electronic device of (12), wherein the circuitry is further configured to control light (800) based on the filtered Event-based Vision Sensor (EVS) data.

(15) A method for training a neural network, the method comprises: mapping audio parameters based on detected Event-based Vision Sensor (EVS) data; comparing (611) ground truth data (608, 609, 610) of the audio parameters with the audio parameters (605, 606, 607) to obtain a comparison result (612); and feeding back to the neural network the comparison result (612) to update the neural network parameters.

(16) A method comprising:
generating (100; 203; 303) Event-based Vision Sensor (EVS) data (106); and
generating and/or controlling (104) sound (107) based on the Event-based Vision Sensor (EVS) data (106).

(17) A computer program comprising instructions, the instructions when executed on a processor causing the processor to perform the method of (16).

(18) An electronic device comprising circuitry configured to
generate (100; 203; 303) Event-based Vision Sensor (EVS) data (106); and
detect vibrations based on the Event-based Vision Sensor (EVS) data (106).

(19) A method comprising:
generating (100; 203; 303) Event-based Vision Sensor (EVS) data (106); and
detecting vibrations based on the Event-based Vision Sensor (EVS) data (106).

(20) A computer program comprising instructions, the instructions when executed on a processor causing the processor to perform the method of (19).

1. An electronic device comprising circuitry configured to
generate Event-based Vision Sensor (EVS) data; and
generate and/or control sound based on the Event-based Vision Sensor (EVS) data.

2. The electronic device of claim 1, wherein the circuitry comprising an Event-based Vision Sensor configured to generate Event-based Vision Sensor (EVS) data.

3. The electronic device of claim 2, wherein the Event-based Vision Sensor (EVS) is configured to generate the Event-based Vision Sensor (EVS) data based on luminance changes from each pixel of Event-based Vision Sensor (EVS).

4. The electronic device of claim 1, wherein the Event-based Vision Sensor (EVS) data are generated based on vibration motion of a sound generator.

5. The electronic device of claim 1, wherein the sound generator is one of a loudspeaker, drum, a guitar amplifier, a bass amplifier.

6. The electronic device of claim 1, wherein the Event-based Vision Sensor (EVS) data generation is related to a gesture movement.

7. The electronic device of claim 1, wherein the circuitry is further configured to perform event mapping to map audio parameters to the Event-based Vision Sensor (EVS) data.

8. The electronic device of claim 7, wherein the circuitry is further configured to change the audio parameters based on the event mapping to obtain the sound.

9. The electronic device of claim 8, wherein the audio parameter is pitch and/or amplitude.

10. The electronic device of claim 8, wherein the circuitry is further configured to perform synthesis based on the audio parameters to generate and/or to control the sound.

11. The electronic device of claim 10, wherein the synthesis comprises audio synthesis being performed based on a timbre.

12. The electronic device of claim 1, wherein the circuitry is further configured to perform quantization and filtering of the Event-based Vision Sensor (EVS) data to obtain filtered event data.

13. The electronic device of claim 12, wherein the circuitry is further configured to perform gesture mapping to map the Event-based Vision Sensor (EVS) data to a detected gesture.

14. The electronic device of claim 12, wherein the circuitry is further configured to control light based on the filtered Event-based Vision Sensor (EVS) data.

15. A method for training a neural network, the method comprises:
mapping audio parameters based on detected Event-based Vision Sensor (EVS) data;
comparing ground truth data of the audio parameters with the audio parameters to obtain a comparison result; and
feeding back to the neural network the comparison result to update the neural network parameters.

16. A method comprising:
generating Event-based Vision Sensor (EVS) data; and
generating and/or controlling sound based on the Event-based Vision Sensor (EVS) data.

17. A computer program comprising instructions, the instructions when executed on a processor causing the processor to perform the method of claim 16.

18. An electronic device comprising circuitry configured to
generate Event-based Vision Sensor (EVS) data; and
detect vibrations based on the Event-based Vision Sensor (EVS) data.

19. A method comprising:
generating Event-based Vision Sensor (EVS) data; and
detecting vibrations based on the Event-based Vision Sensor (EVS) data.

20. A computer program comprising instructions, the instructions when executed on a processor causing the processor to perform the method of claim 19.
